(19) United States
(12) Patent Application Publication
(10) Pub. No.: US 2009/0130331 A1
(43) Pub. Date: May 21, 2009

(54) Method of Forming Thin Film and Method of Manufacturing Semiconductor Device

(75) Inventors: Masayuki Asai, Toyama (JP); Masayuki Tsuneda, Toyama (JP); Shinya Sasaki, Toyama (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., Chiyoda-ku, Tokyo (JP)

(21) Appl. No.: 11/920,720

(22) PCT Filed: Aug. 10, 2006
(86) PCT No.: PCT/JP2006/315846

§ 371 Date: Nov. 20, 2007

(30) Foreign Application Priority Data
Aug. 16, 2005 (JP) 2005-236002

(51) Int. Cl. B05D 5/12

(52) U.S. Cl. 427/535

(57) ABSTRACT

A thin film is deposited on a substrate to be processed by continuously performing: forming an amorphous thin film composed of Ti, N, C, and H as principal components; oxidizing a surface of the thin film; removing C and H, which are impurities in the thin film, by a plasma treatment, and increasing the density of the thin film; and removing a TiO thin film from a surface of the thin film.

### TECHNICAL FIELD

The present invention relates to a method of forming a thin film and a method of manufacturing a semiconductor device, and more particularly relates to a method of forming a TiN thin film and method of manufacturing a semiconductor device that are used in the process of manufacturing a semiconductor device.

### BACKGROUND ART

One step of manufacturing a semiconductor device is a film formation step in which a prescribed film is formed on a substrate using CVD (Chemical Vapor Deposition) and ALD (Atomic Layer Deposition). CVD is a method in which a reaction between the surface and the vapor phase of a gaseous raw material is used, and a thin film whose constituent element is an element that contains raw material molecules is deposited on a substrate to be processed. Among CVD methods, methods that use organic materials are referred to as MOCVD (Metal Organic CVD). Also, among CVD methods, methods in which the thin film deposition is controlled on the atomic layer level are referred to as ALD, and the significant characteristic of ALD is that the substrate temperature is lower than in conventional CVD methods.

Conventionally, a TiN thin film is formed by MOCVD in a manufacturing step of a semiconductor device. A TiN film (CVD-TiN film) formed by some MOCVD methods is sometimes referred to as a barrier metal because the film functions to prevent the diffusion of metals (Al, Cr, Cu) used as wiring.

### DISCLOSURE OF THE INVENTION

### Problems that the Invention is to Solve

However, a conventional CVD-TiN film formed by MOCVD has the following problems.

The first problem is peeling (microcracks). The peeling problem occurs more readily with higher substrate temperatures during TiN deposition. This is due to a considerable difference in the stress between the substrate to be processed and the TiN film, and the temperature of the substrate must be reduced during TiN deposition.

The second problem is the grain boundary. The TiN film formed using a high substrate temperature tends to readily form a polycrystalline structure. A polycrystalline structure is readily formed in the same manner when plasma is used as an energy assist in the formation of TiN at a low temperatures. A polycrystalline TiN film is referred to as poly-TiN, and an amorphous TiN film is designated as a-TiN. The grain boundary of poly-TiN readily reduces the barrier characteristics and causes variability in electrical resistance. Considering the fact that miniaturization will continue in the future and that design rules will be reduced to 65 nm or less, there is a need to contrive a way to prevent polycrystallization.

The third problem is the change in the resistivity of the TiN film over time. The lower the formation temperature of the TiN film is, the greater the change over time due to atmospheric exposure. A TiN film formed at a low temperature has a lower film density, and it is therefore difficult to prevent the progress of oxidation due to atmospheric exposure.

The fourth problem is coverage characteristics. The lower the formation temperature of the TiN film is, the lower the film density is, and the greater the tendency of the electrical characteristics to degrade. In contrast, the coverage characteristics improve in accordance with lower temperatures. However, this leads to an increase in the electrical resistivity, and there is therefore a need for a process technology that can achieve both good electrical characteristics and good coverage.

A major object of the present invention is to provide a method of forming a thin film and a method of manufacturing a semiconductor device in which a TiN film is formed that is not liable to peel, has no grain boundaries or fewer grain boundaries, changes very little over time, and has excellent coverage.

Another major object of the present invention is to provide a method of forming a thin film and a method of manufacturing a semiconductor device in which a TiN film is formed that has good barrier characteristics.

### Means of Solving the Problems

In a first aspect, there is provided a method of manufacturing a thin film wherein a TiN film is deposited on a substrate to be processed by continuously performing the steps of:

forming an amorphous thin film composed of Ti, N, C, and H as principal components;

oxidizing a surface of the thin film;

removing C and H, which are impurities in the thin film, by plasma processing, and increasing the density of the thin film; and

removing a TiO thin film from a surface of the thin film.

In a second aspect, there is provided a method of manufacturing a semiconductor device wherein a TiN film is deposited on a substrate to be processed by continuously performing the steps of:

forming an amorphous thin film composed of Ti, N, C, and H as principal components;

oxidizing a surface of the thin film;

removing C and H, which are impurities in the thin film, by plasma processing, and increasing the density of the thin film; and

removing a TiO thin film from a surface of the thin film.

### EFFECT OF THE INVENTION

In accordance with the present invention, there is provided a method of forming a thin film for forming a TiN film that is not liable to peel, has no grain boundaries or fewer grain boundaries, changes very little over time, and has excellent coverage.

Also, in accordance with the present invention, there is provided a method of manufacturing a semiconductor device in which a TiN film is formed that has good barrier characteristics.

### BRIEF DESCRIPTION OF THE DRAWINGS

FIG. 1 is a schematic longitudinal sectional diagram for describing the vertical substrate processing oven of the substrate processing device related to a preferred example of the present invention;

FIG. 2 is a schematic transverse sectional diagram for describing the vertical substrate processing oven of the substrate processing device related to a preferred example of the present invention;

FIG. 3 is a flowchart for describing the step of forming an amorphous TiNCH thin film as a first step of a preferred example of the present invention;

FIG. 4 is a schematic transverse sectional diagram for describing the state of oxidation of the amorphous TiNCH thin film according to a second step of a preferred example of the present invention;

FIG. 5 is a schematic transverse sectional diagram for describing the plasma processing device that is used in a third step of a preferred example of the present invention;

FIG. 6 is a schematic transverse sectional diagram for describing the state in which a TiO film is removed in accordance with a fourth step of a preferred example of the present invention; and

FIG. 7 is a flowchart for describing another example of the step of forming an amorphous TiNCH thin film as a first step of a preferred example of the present invention.

### KEY

200 Wafer
201 Processing chamber
202 Processing oven
203 Reaction tube
207 Heater
217 Boat
218 Quartz gap
219 Seal cap
220 O ring
224 Plasma generation region
231 Gas exhaust tube
237 Buffer chamber
246 Vacuum pump
267 Boat rotation mechanism
269 Rod-shaped electrode
270 Rod-shaped electrode
272 Matching circuit
273 High frequency power source
275 Electrode protecting tube
321 Controller
331 to 337 Gas supply tubes
361, 362 Nozzles
341 to 346 Mass flow controllers
351 to 356 Valves
371 to 373 Gas supply ports
380 Ground
400 Plasma processing device
401 High frequency power source
402 Matching circuit
403 Electrode
404 Electrode
405 Plasma

### BEST MODE FOR CARRYING OUT THE INVENTION

Next, preferred examples of the present invention will be described.

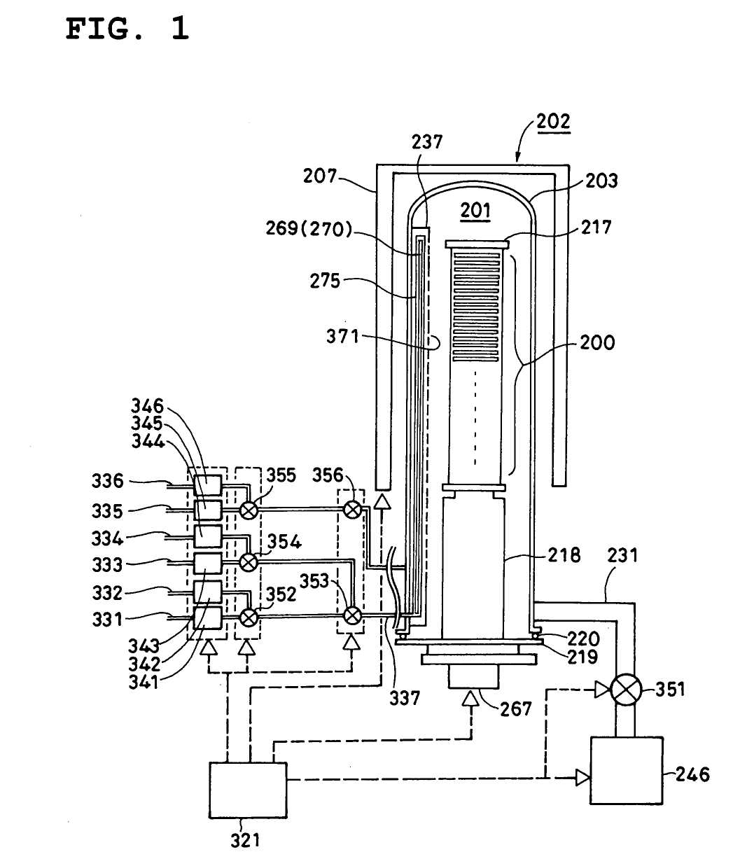

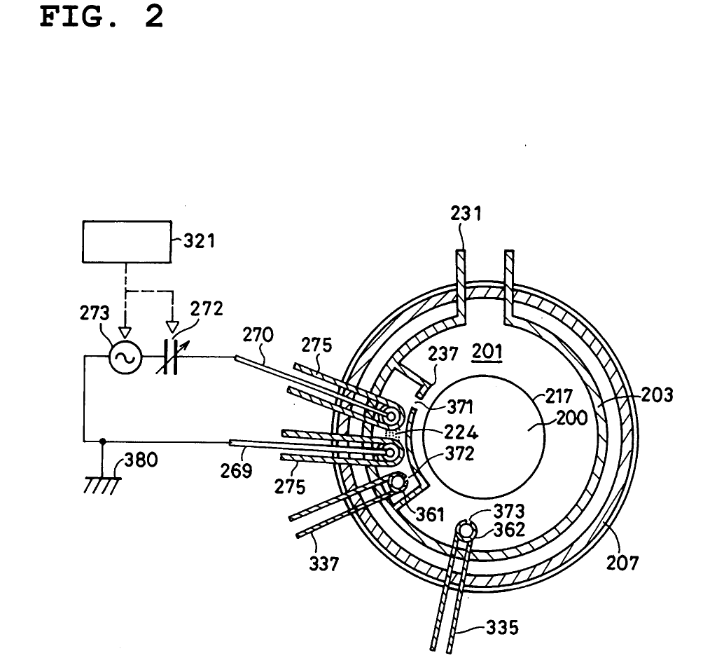

FIG. 1 is a schematic block diagram for describing the vertical substrate processing oven of the preferred examples of the present invention, and shows a longitudinal sectional view of the processing oven portion; and FIG. 2 is a schematic block diagram for describing the vertical substrate processing oven of the preferred examples of the present invention, and shows a transverse sectional view of the processing oven portion.

A quartz reaction tube 203 as a reactor for processing a wafer 200, which is the substrate to be processed, is disposed inside a heater 207 as a heating device, and the lower end opening of the reaction tube 203 is closed in an airtight manner by a seal cap 219 as a lid body via an O ring 220, which is an airtight member. A processing oven 202 is formed from at least the heater 207, the reaction tube 203, and the seal cap 219. A processing chamber 201 is formed from the reaction tube 203, the seal cap 219, and a later-described buffer chamber 237 that is formed inside the reaction tube 203. A boat 217 acting as a substrate holding device is set up on the seal cap 219 via a quartz cap 218, and the quartz cap 218 acts as a holder that holds the boat 217. The boat 217 is loaded into the processing oven 202. A plurality of batch-processed wafers 200 is loaded onto the boat 217 on several horizontally-oriented shelves in the vertical direction (axial direction of the tube). The heater 207 heats the wafers 200 loaded into the processing oven 202 to a prescribed temperature.

Three gas supply tubes 331, 333, and 335 as supply tubes that feed a plurality of types of gas, in this case, three types of gas, are provided to the processing oven 202. NH₃ is fed from the gas supply tube 331, SiH₄ is fed from the gas supply tube 333, and TDMAT (Tetrakis(Dimethylamino)Titanium) and TDEAT (Tetrakis(Diethylamino)Titanium) are fed from the gas supply tube 335.

A gas supply tube 332 is connected to the gas supply tube 331 via a valve 352. The valve 352 switches between the gas supply tube 331 and the gas supply tube 332. A gas supply tube 334 is connected to the gas supply tube 333 via a valve 354. The valve 354 switches between the gas supply tube 333 and the gas supply tube 334. A gas supply tube 336 is connected to the gas supply tube 335 via a valve 355. The valve 355 switches between the gas supply tube 335 and the gas supply tube 336. N₂ is fed from the gas supply tubes 332, 334, 336.

A mass flow controller 341 is disposed in the gas supply tube 331 on the upstream side of the valve 352, and a mass flow controller 342 is disposed in the gas supply tube 332 on the upstream side of the valve 352. A mass flow controller 343 is disposed in the gas supply tube 333 on the upstream side of the valve 354, and a mass flow controller 344 is disposed in the gas supply tube 334 on the upstream side of the valve 354. A mass flow controller 345 is disposed in the gas supply tube 335 on the upstream side of the valve 355, and a mass flow controller 346 is disposed in the gas supply tube 336 on the upstream side of the valve 355. Flow rates are controlled by the mass flow controllers 341 to 346.

The gas supply tube 331 and gas supply tube 333 are connected to a gas supply tube 337 via a valve 353. The valve 353 switches between the gas supply tube 331 and the gas supply tube 333.

A valve 356 is disposed in the gas supply tube 335 on the downstream side of the valve 355.

Gas is fed from the gas supply tube 337 to the processing chamber 201 via a later-described buffer chamber 237 that is formed inside the reaction tube 203. Gas is fed from the gas supply tube 335 to the processing chamber 201 via a later-described nozzle 362 that is formed inside the reaction tube 203.

The processing chamber 201 is connected to a vacuum pump 246 acting as an exhaust device via a valve 351 through a gas exhaust tube 231, which is an exhaust tube for exhausting gas, and is evacuated.

The valve 351 is an on-off valve that can be can be opened and closed to evacuate or stop the evacuation of the processing chamber 201 and the position of the valve can be adjusted to adjust the pressure.

The buffer chamber 237 acting as a gas dispersion space is disposed along the loading direction of the wafer 200 on the inner wall from the lower portion to the upper portion of the reaction tube 203 in the arcuate space between the wafer 200 and the inner wall of the reaction tube 203, which is part of the processing chamber 201. Gas supply ports 371 acting as supply ports that feed gas are provided to the vicinity of the end portion of the inner wall adjacent to the wafer 200 of the buffer chamber 237. The gas supply ports 371 are opened toward the center of the reaction tube 203. The gas supply ports 371 each have the same aperture surface area over a prescribed length from the lower portion to the upper portion along the loading direction of the wafer 200, and are furthermore disposed at the same aperture pitch.

A nozzle 361 is disposed along the loading direction of the wafers 200 from the lower portion to the upper portion of the reaction tube 203 in the vicinity of the end portion on the opposite side from the end portion on which the gas supply ports 371 of the buffer chamber 237 are disposed. The gas supply tube 335 is connected to the lower end of the nozzle 361.

A plurality of gas supply ports 372 acting as supply ports that feed gas is provided to the nozzle 361. The plurality of gas supply ports 372 is disposed along the loading direction of the wafers 200 across the same prescribed length as described for the gas supply ports 371. The plurality of gas supply ports 372 and the plurality of gas supply ports 371 are disposed in a one-to-one corresponding relationship.

When the pressure difference between the buffer chamber 237 and the processing chamber 201 is low, the aperture surface area of the gas supply ports 372 may be the same from the upstream side to the downstream side, and the aperture pitch may be the same. However, when the pressure difference is considerable, the aperture surface area may be increased or the aperture pitch may be reduced from the upstream side to the downstream side.

The aperture surface area and aperture pitch of the gas supply ports 372 are adjusted from the upstream side to the downstream side, whereby, first, gas is discharged substantially at the same flow rate from each gas supply port 372, although there may be differences in the flow velocity of the gas. Next, the gas discharged from the gas supply ports 372 is discharged into the buffer chamber 237. With the gas thus introduced, differences in gas flow rate can be made uniform.

In other words, in the buffer chamber 237, the velocity of the gas particles is reduced in the buffer chamber 237, and the gas discharged from the gas supply ports 372 is discharged from the gas supply ports 371 into the processing chamber 201. In this interval, the gas discharged from the gas supply ports 372 is discharged from the gas supply ports 371, whereby the gas can be given a uniform flow rate and flow velocity.

Furthermore, a rod-shaped electrode 269 and a rod-shaped electrode 270 that have a long thin structure are disposed in the buffer chamber 237 and are protected by electrode protection tubes 275, which are protection tubes that protect the electrodes and extend from the upper portion to the lower portion. The rod-shaped electrode 270 is connected to a high frequency power source 273 via a matching circuit 272, and the rod-shaped electrode 269 is connected to a ground 380, which is the reference potential. As a result, plasma is generated in the plasma generation area 224 between the rod-shaped electrode 269 and the rod-shaped electrode 270.

The electrode protection tubes 275 have a structure that allows loading into the buffer chamber 237 in a state in which the rod-shaped electrode 269 and the rod-shaped electrode 270 are set at a distance from each other, with the atmosphere of the buffer chamber 237 disposed therebetween. In this configuration, if the interior of the electrode protection tube 275 has the same atmosphere as the outside air (atmospheric air), the rod-shaped electrode 269 and rod-shaped electrode 270 inserted into the electrode protection tubes 275 will be oxidized by the heating of the heater 207. In view of this situation, an inert gas purge mechanism is provided in order to purge or fill the interior of the electrode protection tubes 275 with nitrogen or another inert gas, sufficiently reduce the oxygen concentration, and prevent the rod-shaped electrode 269 and rod-shaped electrode 270 from being oxidized.

A nozzle 362 is disposed in the inner wall about 1000 around the inner periphery of the reaction tube 203 from the position of the gas supply ports 371. The nozzle 362 is a supply part that handles the supply of gas species together with the buffer chamber 237 when a plurality of gases is fed one type of gas at a time in alternating fashion to the wafers 200 during ALD film formation.

The nozzle 362 has gas supply ports 373, which are supply ports that feed gas and are disposed at the same pitch in positions adjacent to the wafers in the same manner as the buffer chamber 237, and the gas supply tube 335 is connected at the lower portion.

When the pressure difference between the buffer chamber 237 and the processing chamber 201 is low, the aperture surface area of the gas supply ports 373 may be the same from the upstream side to the downstream side, and the aperture pitch may be the same. However, when the pressure difference is considerable, the aperture surface area may be increased or the aperture pitch may be reduced from the upstream side to the downstream side.

A boat 217 on which a plurality of wafers 200 is loaded on several shelves in the vertical direction at equal intervals is disposed in the center area inside the reaction tube 203, and the boat 217 can be loaded to and unloaded from the reaction tube 203 by a boat elevator mechanism that is not depicted in the diagrams. A boat rotation mechanism 267, which is rotation device for rotating the boat 217, is provided for improving the uniformity of the process. The boat rotation mechanism 267 rotates to thereby rotate the boat 217 held on the quartz cap 218.

A controller 321 is a control device that is connected to the mass flow controllers 341 to 346, the valves 351 to 356, the heater 207, the vacuum pump 246, the boat rotation mechanism 267, the boat elevator mechanism (not shown), the high frequency power source 273, and the matching circuit 272, and functions to adjust the flow rate of the mass flow controllers 341 to 346, switchably operate the valves 352 to 355, open and close the valve 356, open and close the valve 351 and adjust the pressure, adjust the temperature of the heater 207, start and stop the vacuum pump 246, adjust the rotational speed of the boat rotation mechanism 267, control the elevator operation of the boat elevator mechanism (not shown), control the supply of power produced by the high frequency power source 273, and control impedance using the matching circuit 272.

Next, the method of forming a TiN film will be described in accordance with preferred examples of the present invention.

Preferred examples of the present invention were contrived based on the following findings. A film must be densely formed in order to obtain an amorphous TiN film that has considerable film density. An amorphous TiN film is liable to crystallize when densely formed using plasma processing. The surface of the TiN film can be oxidized to form a chemically stable TiO-based oxide film in order to reduce polycrystallization of the amorphous TiN film. C, H, and other impurities can be added to the TiN film so as to easily oxidize the amorphous TiN film. The unnecessary C and H can be removed by reforming when the density of TiN film is increased. A TiN film having the intended high film density can be obtained by removing the unnecessary TiO film from the surface of the thin film.

The method of forming a TiN film according to preferred examples of the present invention is composed of the four steps described below, and a silicon wafer 200 as a substrate to be processed is processed in accordance with the sequence of steps.

Step 1: A step of forming an amorphous TiNₓC_{y}H_{z} (hereinafter merely referred to as TiNCH) thin film

Step 2: A step for exposing the amorphous TiNCH thin film to atmospheric air and naturally oxidizing the surface

Step 3: A step of removing impurities (C and H) in the film by using plasma processing, and making the film denser.

Step 4: A step for removing a TiO thin film from the surface of the thin film.

The four steps described above allow a dense amorphous TiN thin film to be formed on the substrate surface, wherein peeling is less liable to occur, change over time is reduced, and coverage characteristics are excellent. The manner in which a TiN thin film is formed will be described below in each step.

Step 1: Formation of an Amorphous TiN Thin Film

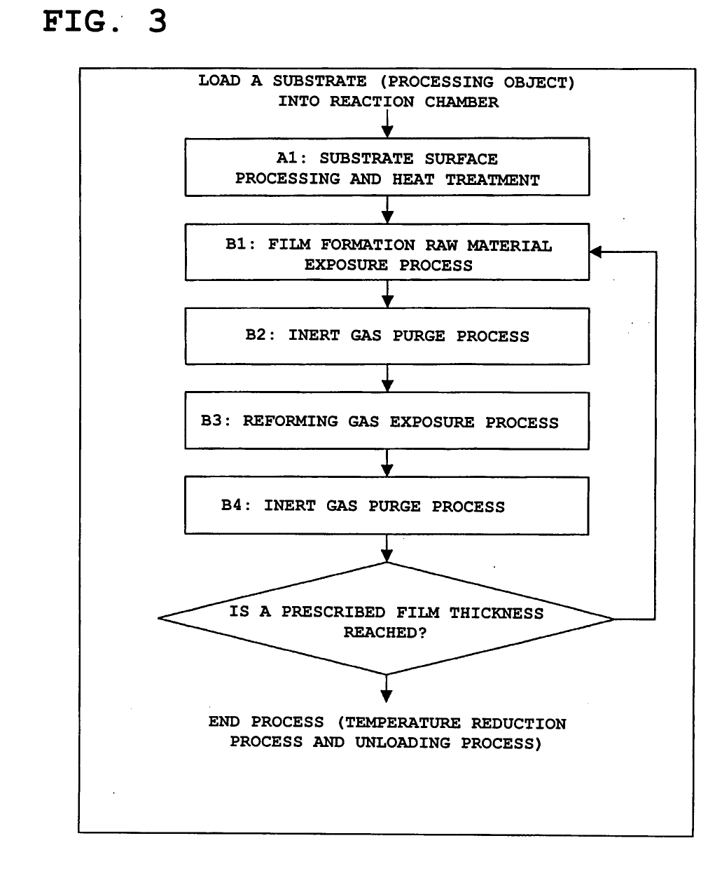

In this step, the devices shown in, e.g., FIGS. 1 and 2 described above are used. The materials used for film formation are TDMAT (Tetrakis(Dimethylamino)Titanium: Ti(N(CH₃)₂)₄) and TDEAT (Tetrakis(Diethylamino)Titanium: Ti(N(C₂H₅)₂)₄); and the reforming gas is NH₃, SiH₄, H₂, N₂, Ar, and the like. An example of the substrate processing flow in the present step is shown in FIG. 3.

In the devices shown in FIGS. 1 and 2, substrates to be processed are loaded into the boat 217, the boat 217 is then loaded into the reaction tube 203, and the substrate surface processing and heat processing is started (step A1). The processing described below constitutes step A1, which may be suitably carried out in accordance with the state of the surface of the substrate to be processed.

(1) Pressure Reduction Process

The pressure inside the reaction tube 203 is reduced by the vacuum pump 246, whereby the impurities deposited on the surface of the substrate are removed.

(2) Inert Gas Cycle Purge Process

This process entails periodically introducing inert gas inside the pressure-reduced reaction tube 203 via the nozzle 361, and absorbing away the impurities deposited on the surface of the substrate into the inert gas. This process may be carried out while heating the substrate.

(3) Plasma Surface Treatment (Plasma Surface Oxidation Treatment and Plasma Surface Reduction Treatment)

This treatment is a treatment in which the high frequency power source 273 is used to generate electric discharge between the rod-shaped electrode 269 and rod-shaped electrode 270 to generate plasma inside the buffer chamber 237 while surface treatment gas is introduced from the nozzle 361 into the pressure-reduced chamber 203. As a result of this treatment, the surface treatment gas that has been treated by the plasma is brought through the gas supply ports 371 disposed in the buffer chamber 237 and directed to the surface of the substrate. The present treatment is carried out after processes (1) and (2) described above have been performed, is a treatment used for removing impurities deposited on the surface of the substrate, and may be carried out while the wafers 200 are being rotated by the boat rotation mechanism 267. The surface treatment gas that is used during the plasma surface oxidation treatment is mainly O₂ and is a reforming gas having the effect of an oxidizing agent. In contrast, the surface treatment gas that is used during the plasma surface reduction treatment is mainly H₂ and is a reforming gas having the effect of a reducing agent.

Both the plasma surface oxidation treatment and the plasma surface reduction treatment are usually carried out. In such a case, the plasma surface reduction treatment is carried out first, and the plasma surface oxidation treatment is carried out thereafter.

However, there are cases in which only one of the treatments need be performed, e.g., only oxidation needs to be carried out when reduction has been completed, or only reduction is carried out when oxidation of the substrate surface is not desired.

Heat treatment is started by the boat 217 is loaded in the reaction tube 203. The temperature of the reaction tube 203 is kept constant by the heater 207, and the wafers 200 are heated and kept at a prescribed temperature. The temperature maintained is preferably a film formation temperature that conforms to the film formation raw material as described below.

Next, the processes of steps B1 to B4 are carried out using the ALD method, and an amorphous TiNCH thin film is formed on the substrate.

When the film formation raw material is TDMAT: Ti(N(CH₃)₂)₄), the film formation temperature (substrate temperature) is preferably 100 to 200° C. This is because a thin film with good coverage can be formed in this temperature range on a circuit pattern that is formed on a substrate. It is apparent that the temperature range differs depending on the film formation raw material that is used.

The film formation raw material exposure process of step B1 is a process for depositing film formation raw material on the surface of the substrate to be processed. The inert gas purge process of step B2 is a process that is designed to make the deposited film formation raw material uniform. The reforming gas exposure process of step B3 is a process in which the deposited film formation raw material and reforming gas are caused to react and an amorphous TiNCH thin film on the level of an atomic layer is formed. The inert gas purge process of step B4 is a process whereby reaction byproducts generated in step B3 are removed from the reaction chamber.

The reforming gas used in the reforming gas exposure process of step B3 is not a plasma gas, and H₂ or an H₂-containing reforming gas may be used, or NH₃, N₂, or Ar may be used.

The amorphous TiNCH thin film that is formed by repeating the steps B1 to B4 is an amorphous film containing Ti, N, C, and H, and the surface of the film is prone to oxidation in an atmosphere that contains moisture.

The processes in steps B1 to B4 are repeated until an amorphous TiNCH thin film is formed to a prescribed film thickness. The thickness of the amorphous TiNCH thin film is preferably about 5 to 20 nm, assuming the removal of impurities as described hereinafter. The mean of the electrical resistivity is preferably about 0.01 to 1,000 Ω·cm. At this time, polycrystals will form in the case of TiN having 0.01 Ω·cm or less, and the reforming results of steps 2 to 4, which are later steps, will be more difficult to obtain. Therefore, such a value is unsuitable. Also, in steps B2 to B3, the reforming gas may be excited using weak plasma, but polycrystallization is difficult prevent. The plasma treatment is the same as the plasma surface treatment described above.

The process that ends the first step is carried out when the thickness of the amorphous TiNCH thin film has reached the prescribed film thickness. The end process is composed of a temperature reduction process and an unloading process. The temperature reduction process is a process in which the temperature of the reaction tube 203 is reduced to a prescribed temperature. The unloading process is a process in which the substrate to be processed on which an amorphous thin film has been formed is unloaded from the processing oven 202 together with the boat 217.

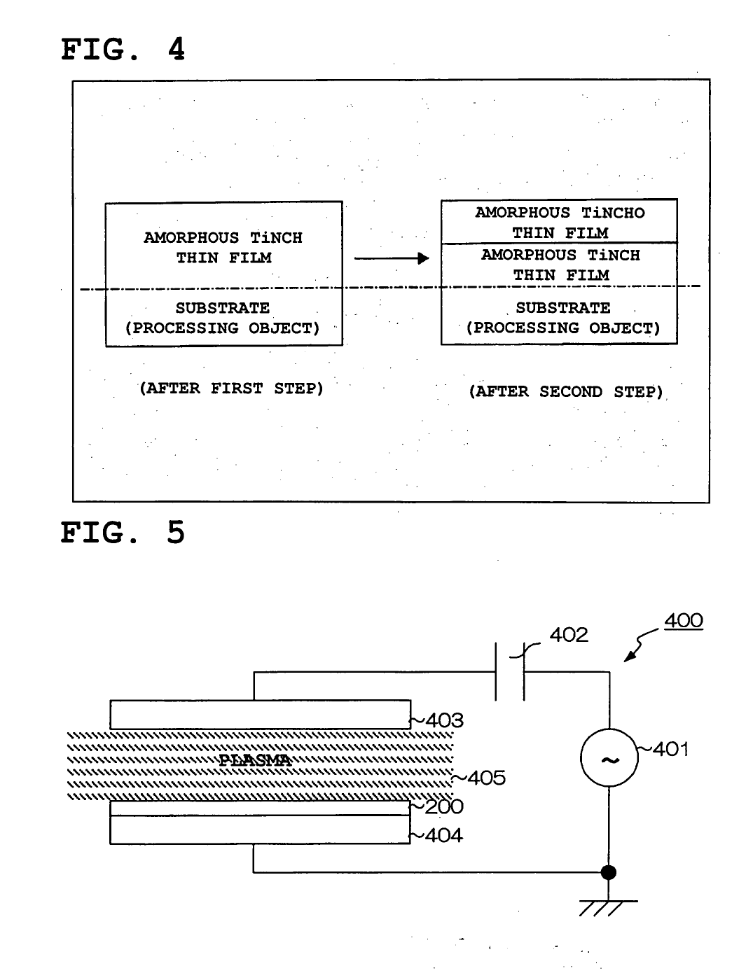

The second step, which is “a step in which an amorphous TiNCH thin film is exposed to the atmosphere to naturally oxidize the surface,” is a process for making the oxidation treatment uniform. Specifically, in the second step, the substrate to be processed is placed in atmospheric air in which the moisture concentration has been controlled, the substrate temperature is kept at a fixed level of about 50° C., and atmospheric oxidation is carried out for a prescribed length of time. FIG. 4 shows the state of oxidation in the second step. An amorphous TiNCHO thin film is formed on the surface of the amorphous TiNCH thin film

Step 3 is subsequently carried out on the thin film in the state shown in FIG. 4. Step 3 is composed of a process for removing impurities (C, H) in the film by treating the surface of the substrate with plasma, and a process for making the amorphous thin film denser. The two processes can be made to proceed simultaneously using the plasma treatment described below.

The plasma treatment of step 3 is carried out using a plasma processing device 400, which is schematically shown in FIG. 5. The plasma processing device 400 is provided with parallel flat electrodes 403 and 404 that face each other. The electrode 404 is grounded, and the electrode 403 is connected to a high frequency power supply 401 via a matching circuit 402. The silicon wafer 200, which is the substrate, is mounted on the electrode 404. High frequency power is applied between the electrodes 403 and 404 by the high frequency power supply 401, and plasma 405 is generated between the electrodes 403 and 404 so that the plasma 405 makes contact with the wafer 200.

The reforming gas to be excited by plasma may be H₂ or H₂-containing reforming gas. Ar or another inert gas may also be added to the H₂ or H₂-containing reforming gas. Subsequent to such H₂ plasma treatment, the surface may be nitrided by an NH₃ plasma treatment.

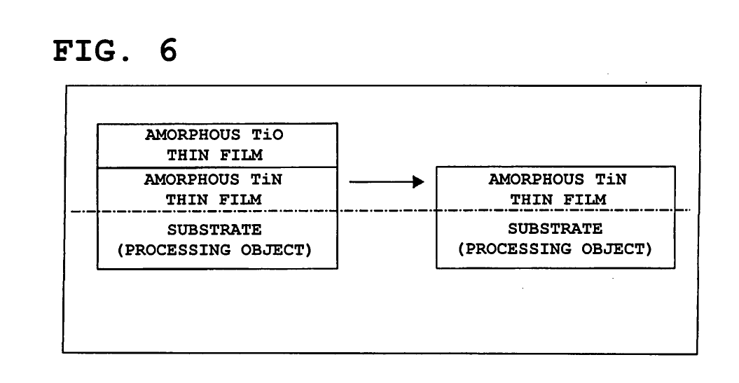

Next, the step for removing the TiO thin film on the surface of the thin film of step 4 is carried out as the final step. This step is a step for removing an amorphous TiO film formed on the surface of the substrate after step 3. This process is an ordinary acid-based washing process. The amorphous TiO film on the surface can be removed in a simple manner by exposing the substrate to HF or another aqueous solution for a prescribed length of time which keeping the substrate temperature constant. A dense amorphous TiN film is left on the substrate, as shown in FIG. 6.

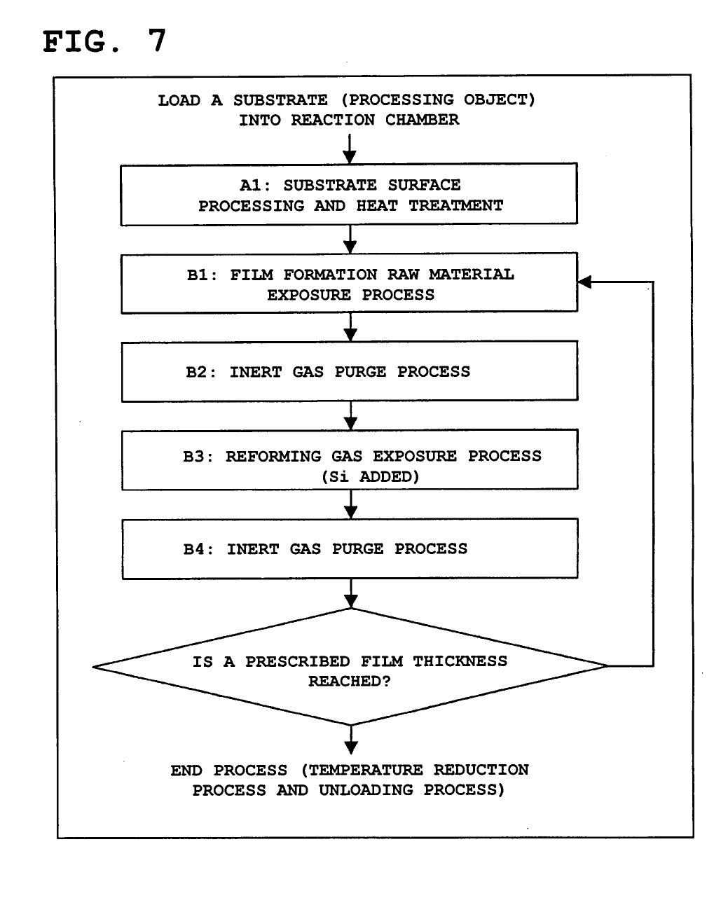

A gas containing Si atoms, e.g., SiH₄, is added to the reforming gas during the process of step B3 in step 1, as shown in FIG. 7, whereby an amorphous TiN film that contains a small amount of Si and is not liable to crystallized is more easily obtained in the after-treatments of steps 2 to 4. In this case, plasma cannot be used in the process of step B3, but this approach is effective in terms of preventing the TiN film from crystallizing.

Amorphous TiNCH is also formed on the boat 217 and the inner wall of the reaction tube 203 when an amorphous thin film is formed in step 1 in the present example, but since the film as such is a low-density amorphous thin film, self-cleaning can be carried out using NF₃ gas to remove the [amorphous thin film] in a simple manner. Therefore, the cleaning cycle of the film formation device can be extended and maintenance properties can be improved by using the present example. Equipment (actions) for cleaning the dense TiN film or otherwise improving the corrosion resistance of the device itself are not required, device costs can be reduced, and economic efficiency can be improved.

As described above, in accordance with the preferred examples of the present invention, a dense amorphous TiN film can be formed in which the coverage is excellent, peeling is not liable to occur, an amorphous TiN film having high barrier characteristics can be formed, and change over time due to oxidation in the atmosphere is very low.

Preferred embodiments of the present invention are described below.

A first aspect provides a method of manufacturing a thin film including: forming an amorphous thin film composed of Ti, N, C, and H as principal components; and oxidizing a surface of the thin film. Because of the formation of an amorphous thin film composed of Ti, N, C, and H as principal components, oxidation of the amorphous thin film is facilitated.

Next, [the first aspect] comprises a method of manufacturing a thin film in which steps are carried out to remove C and H, which are impurities in the thin film, by a plasma treatment, and to increase the density of the thin film; and to remove a TiO thin film from a surface of the thin film. Since the surface of the amorphous thin film is oxidized and the TiO-based oxide film is protected, polycrystallization of the amorphous thin film can be reduced when the density is increased by a plasma treatment. Also, C and H, which are impurities in the thin film, are removed by the plasma treatment. Since unnecessary TiO thin film is removed, a denser TiN thin film can be obtained.

Included is a method of forming a thin film in which a TiN film is deposited on the substrate to be processed by continuously performing the thin film formation step, the oxidizing step, the impurities removal and density increasing step, and the TiO thin film removal step. Since the above-described steps are carried out in a sequential fashion, a TiN film can be formed in which peeling is not liable to occur and coverage is excellent because a thin film is formed at a low temperature. In this film, there are no grain boundaries or fewer grain boundaries because the amorphous thin film is oxidized, and fewer changes occur over time because the density of the thin film has been increased.

A second aspect provides the method of manufacturing a thin film according to the first aspect wherein a Ti-containing first gas and a second gas containing a reforming gas are alternately and repeatedly fed a prescribed number of times to the substrate to be processed in the step of forming the amorphous thin film.

A first gas and a second gas are alternately and repeatedly fed to the substrate to be processed, whereby an amorphous thin film can be formed at a lower temperature, and a TiN film that is less liable to peel and that has excellent coverage can therefore be formed.

A third aspect provides the method of manufacturing a thin film according to the second aspect wherein the second gas is a Si-containing gas.

A Si-containing amorphous thin film that is less likely to crystallize is more easily obtained, and a TiN film that has no grain boundaries or fewer grain boundaries can be formed.

A fourth aspect provides the method of manufacturing a thin film according to the third aspect wherein the Si-containing gas is SiH₄.

A SiH₄-containing amorphous thin film that is less likely to crystallize is more easily obtained, and a TiN film that has no grain boundaries or fewer grain boundaries can be formed.

A fifth aspect provides the method of manufacturing a thin film according to the first aspect wherein the mean electrical resistivity of the thin film formed in the aforementioned forming the amorphous thin film is 0.01 to 1000 Ω·cm.

When the mean electrical resistivity of the thin film is 0.01 to 1000 Ω·cm, an amorphous thin film that is less likely to crystallize is more easily obtained, and a TiN film that has no grain boundaries or fewer grain boundaries can be formed.

A sixth aspect provides the method of manufacturing a thin film according to first aspect wherein the TiN film deposited on the substrate to be processed is an amorphous TiN film.

When the TiN film deposited on the substrate to be processed is an amorphous TiN film, a TiN film that has no grain boundaries or fewer grain boundaries can be formed.

A seventh aspect provides the method of manufacturing a thin film according to the first aspect wherein a surface of the thin film is naturally oxidized in the atmosphere in the aforementioned oxidizing.

The amorphous thin film is composed of Ti, N, C, and H as the principal components, and a TiN film that has no grain boundaries or fewer grain boundaries can therefore be formed because the surface of the thin film can be naturally oxidized in a simple manner under an atmosphere of atmospheric air.

An eighth aspect provides the method of manufacturing a thin film according to the first aspect wherein an H-containing gas excited by plasma is fed to the oxidized surface in the aforementioned removing C and H, which are impurities in the thin film, and in the aforementioned increasing the density of the thin film.

An H-containing gas excited by plasma is fed to the oxidized surface, and a TiN film that undergoes fewer changes over time can therefore be formed.

A ninth aspect provides the method of manufacturing a thin film according to the eighth aspect wherein nitriding a surface of the thin film is provided subsequent to the aforementioned increasing the density.

Since a step of nitriding a surface of the thin film is furthermore provided, a TiN film that undergoes fewer changes over time can be formed.

A tenth aspect provides the method of manufacturing a thin film according to the first aspect wherein the TiO thin film is removed using an acid-based aqueous solution in the aforementioned removing the TiO thin film.

The TiO thin film can be removed in a simple manner by using an acid-based aqueous solution when the TiO thin film is an amorphous TiO thin film.

An eleventh aspect provides a method of manufacturing a semiconductor device for depositing a TiN film on a substrate to be processed by continuously performing: forming an amorphous thin film composed of Ti, N, C, and H as principal components; oxidizing a surface of the thin film; removing C and H, which are impurities in the thin film, by a plasma treatment, and increasing the density of the thin film; and removing a TiO thin film from a surface of the thin film.

The thin film is formed at a low temperature, whereby a TiN film can be formed in which peeling is not liable to occur, coverage is excellent, the amorphous thin film has no grain boundaries or fewer grain boundaries because the film is oxidized, the thin film is densified, and fewer changes occur over time. Therefore, the barrier characteristics can be improved.

1. A method of manufacturing a thin film for depositing a TiN film on a substrate to be processed by continuously performing:
forming an amorphous thin film composed of Ti, N, C, and H as principal components;
oxidizing a surface of said thin film;
removing C and H, which are impurities in said thin film, by a plasma treatment, and increasing the density of said thin film; and
removing a TiO thin film from a surface of said thin film.

2. The method of manufacturing a thin film according to claim 1, wherein a Ti-containing first gas and a second gas containing a reforming gas are alternately and repeatedly fed a prescribed number of times to the substrate to be processed in said forming the amorphous thin film.

3. The method of manufacturing a thin film according to claim 2, wherein the second gas is a Si-containing gas.

4. The method of manufacturing a thin film according to claim 3, wherein the Si-containing gas is SiH₄.

5. The method of manufacturing a thin film according to claim 1, wherein the mean electrical resistivity of the thin film formed in said forming the amorphous thin film is 0.01 to 1000 Ω·cm.

6. The method of manufacturing a thin film according to claim 1, wherein the TiN film deposited on the substrate to be processed is an amorphous TiN film.

7. The method of manufacturing a thin film according to claim 1, wherein a surface of said thin film is naturally oxidized in the atmosphere in said oxidizing.

8. The method of manufacturing a thin film according to claim 1, wherein an H-containing gas excited by plasma is fed to the oxidized surface in said removing C and H, which are impurities in said thin film, and in said increasing the density of said thin-film.

9. The method of manufacturing a thin film according to claim 8, wherein nitriding a surface of said thin film is provided subsequent to said increasing the density.

10. The method of manufacturing a thin film according to claim 1, wherein said TiO thin film is removed using an acid-based aqueous solution in said removing the TiO thin film.

11. A method of manufacturing a semiconductor device, for depositing a TiN film on a substrate to be processed by continuously performing:
forming an amorphous thin film composed of Ti, N, C, and H as principal components;
oxidizing a surface of said thin film;
removing C and H, which are impurities in said thin film, by a plasma treatment, and increasing the density of said thin film; and
removing a TiO thin film from a surface of said thin film.
